(19) United States
(12) Patent Application Publication
(10) Pub. No.: US 2018/0016666 A1
(43) Pub. Date: Jan. 18, 2018

(54) METHOD OF MANUFACTURING METAL CASTINGS

(71) Applicant: GM Global Technology Operations LLC, Detroit, MI (US)

(72) Inventors: Christopher D. Cogan, Clarkston, MI (US); Qigui Wang, Rochester Hills, MI (US); Maurice G. Meyer, Fenton, MI (US)

(21) Appl. No.: 15/212,905

(22) Filed: Jul. 18, 2016

(51) Int. Cl. C22F 1/04; F02F 7/00; F02F 1/24; B22C 9/10; B22C 9/08; B22D 15/02; B22C 9/24; B22D 21/00; B22D 29/00

(52) U.S. Cl. CPC C22F 1/04; B22D 21/007; F02F 7/0085; F02F 1/24; B22D 29/00; B22C 9/08; B22D 15/02; B22C 9/24; B22C 9/10; F02F 2200/06

(57) ABSTRACT

A method of manufacturing an aluminum alloy cylinder head includes providing a mold assembly including a gating system, a head deck mold, and a mold cavity. Liquid aluminum alloy is pumped at low pressure into the gating system of the mold assembly filling the mold cavity. Next, the head deck mold is removed from the mold assembly and the head deck and combustion chambers of the cylinder head are quenched.

### TECHNICAL FIELD

The present disclosure relates to metal casting processes and more particularly to a low pressure semi-permanent mold aluminum alloy casting processes.

### BACKGROUND

The statements in this section merely provide background information related to the present disclosure and may or may not constitute prior art.

Many different casting processes are currently in use which produce high performance aluminum alloy cylinder heads. Low pressure permanent and semi-permanent mold cast processes use sand cores for internal passages and features. However, these processes tend to produce castings having low mechanical properties. While castings made using a process known as Rotacast®, a registered mark of Nemak, have improved mechanical properties, the process tends to have a high associated cost due to long cycle times and low yield.

Thus, some current aluminum casting processes produce less expensive castings having lower mechanical properties. Other processes produce castings with high mechanical properties at an increased cost. Accordingly, there is a need in the art for an improved casting process that produces high quality, high performance aluminum castings at a lower, more competitive cost.

### SUMMARY

The present invention provides a method of manufacturing an aluminum alloy cylinder head. The method includes providing a mold assembly including a gating system, a head deck mold, and a mold cavity. Next, the method pumps liquid aluminum alloy into the gating system of the mold assembly and filling the mold cavity. The head deck mold is removed from the mold assembly. Next, the head deck and combustion chamber surface of the cylinder head formed by the head deck mold is quenched or is cooled very rapidly.

In one aspect of the present invention, providing a mold assembly including a gating system, a head deck mold, and a mold cavity further includes providing a mold assembly including a cope mold, and a drag mold. The gating system is included in the cope mold, the head deck mold is included in the drag mold, and the mold assembly is inverted.

In another aspect of the present invention, providing a mold assembly including a gating system, a head deck mold, and a mold cavity further includes providing a mold assembly made of predominantly sand and resin and including a head deck mold made of metal.

In yet another aspect of the present invention, pumping liquid aluminum alloy into the gating system of the mold assembly and filling the mold cavity further includes pumping liquid aluminum alloy into the gating system of the cope mold and completely filling the mold cavity.

In yet another aspect of the present invention, removing the head deck mold from the mold assembly further includes rotating the mold assembly and removing the head deck mold from the mold assembly.

In yet another aspect of the present invention, quenching a head deck and combustion chamber surface of the cylinder head further comprises spraying the head deck and combustion chamber surface of the cylinder head with air, water, or a combination of air and water.

In yet another aspect of the present invention, the method further includes transferring the filled mold assembly to an oven for cleaning and heat treatment after casting in the mold assembly is solidified.

In yet another aspect of the present invention, pumping liquid aluminum alloy into the gating system of the mold assembly and filling the mold cavity further includes pumping liquid aluminum into the gating system using an electromagnetic aluminum pump.

The above features and advantages and other features and advantages of the present invention are readily apparent from the following detailed description of the best modes for carrying out the invention when taken in connection with the accompanying drawings.

### BRIEF DESCRIPTION OF THE DRAWING

The drawings described herein are for illustration purposes only and are not intended to limit the scope of the present disclosure in any way.

FIG. 1 is a bottom view of a cylinder head casting according to the principles of the present invention;

FIG. 2 is a perspective view of a cylinder head casting according to the principles of the present invention;

FIG. 3 is a partially assembled view of a mold assembly according to the principles of the present invention;

FIG. 4 is a perspective cut-away view of a mold assembly according to the principles of the present invention;

FIG. 5 is a perspective view of a pair of permanent mold inserts according to the principles of the principles of the present invention

FIG. 6A is an end view of a mold assembly at a start of a casting method according to the principles of the present invention;

FIG. 6B is a side view of a mold assembly at a start of a casting method according to the principles of the present invention;

FIG. 7A is an end view of a mold assembly during a casting method according to the principles of the present invention;

FIG. 7B is a side view of a mold assembly during a casting method according to the principles of the present invention;

FIG. 8A is an end view of a mold assembly during a casting method according to the principles of the present invention;

FIG. 8B is a side view of a mold assembly during a casting method according to the principles of the present invention;

FIG. 9 is a perspective bottom view of a mold assembly during a step of a casting method according to the principles of the present invention, and

FIG. 10 is a flowchart depicting a method according to the principles of the present invention.

### DESCRIPTION

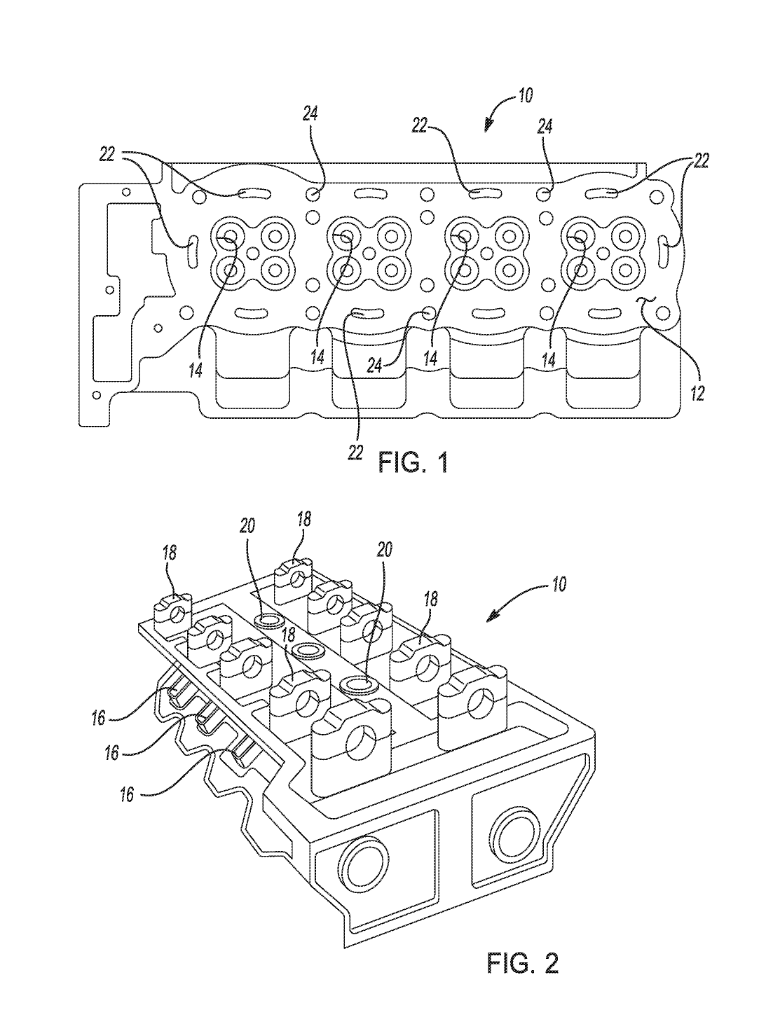

Referring to the drawings, wherein like reference numbers refer to like components, in FIGS. 1 and 2 an aluminum alloy cylinder head 10 produced using a semi-permanent mold casting method is illustrated in accordance with an example of the present invention and will now be described. In general, the cylinder head 10 includes features such as a head deck 12, combustion chambers 14, intake and exhaust ports 16, camshaft bearings 18, spark plug holes 20, water jacket openings 22, and oil passages 24, among other features. More particularly, the important features of the cylinder head 10 that are at least partially formed during the casting process include the head deck 12 and combustion chambers 14. Product specifications for the head deck 12 and combustion chambers 14 generally require higher yield and tensile strength than other areas of the cylinder head 10. For example, faster cooling rates of aluminum alloys produce finer microstructure; approximately 20 μm dentritic arm spacing (DAS). Other areas of the cylinder head 10 that cool at a slower rate may result in DAS of about 60 μm.

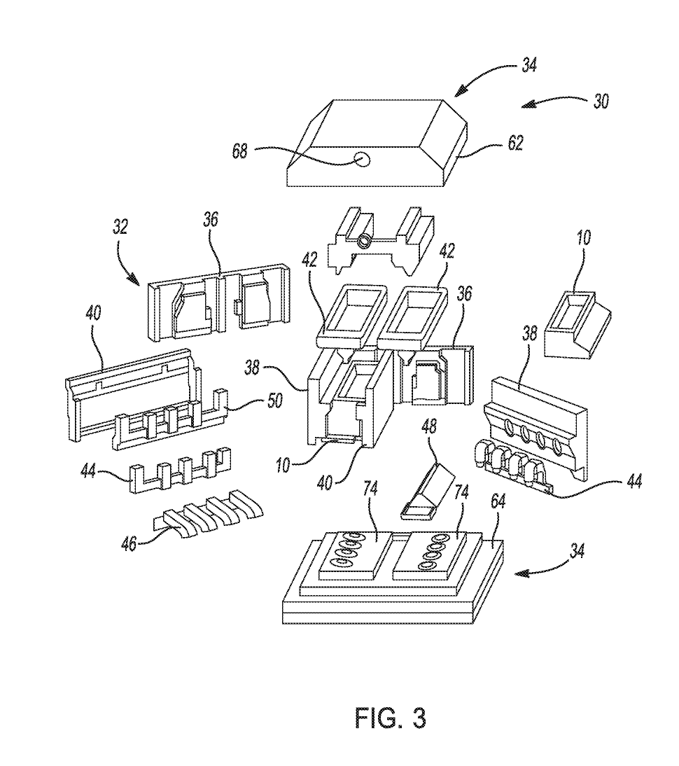

Turning now to FIG. 3, a mold assembly 30 used in a casting method to produce cylinder heads 10 according to a method of the present invention is illustrated and will now be described. This particular mold assembly 30 produces two cylinder head 10 castings in a mold cavity 8 formed by a number of sand cores 32 and sand molds 34. The sand cores 32 form part of the exterior features and all the interior features of the cylinder head 10 casting and includes, for example, two end cores 36, two side cores 38, two center cores 40, two head cover cores 42, two exhaust port cores 44, two intake port cores 46, two water jacket cores 48, and two oil drain cores 50. The sand molds 34 include an upper or cope mold 62 and a lower or drag mold 64. During assembly of the mold assembly 30, all of the sand cores 32 are inserted in specified order into the drag mold 64. Once the sand cores 32 are in place, the cope mold 62 is placed on top of the assembled sand cores 32 thus securing the sand cores 32 in place. Some sand cores 32 may require adhesive, screws, and other retention mechanisms to hold the sand cores 32 in place. However, such practices are within the scope of the present invention.

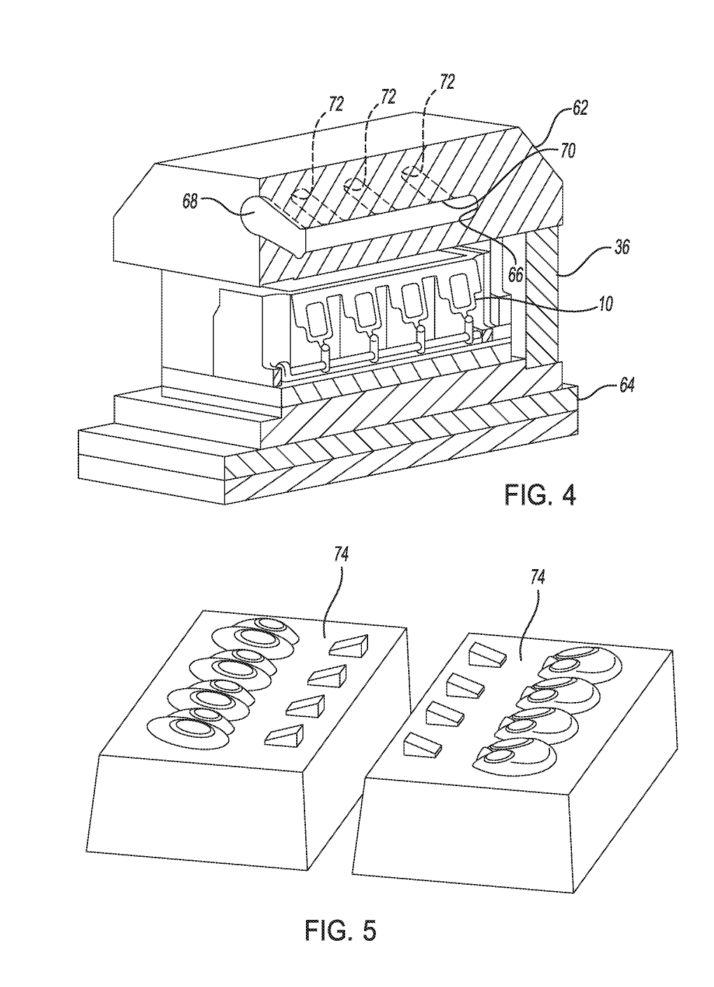

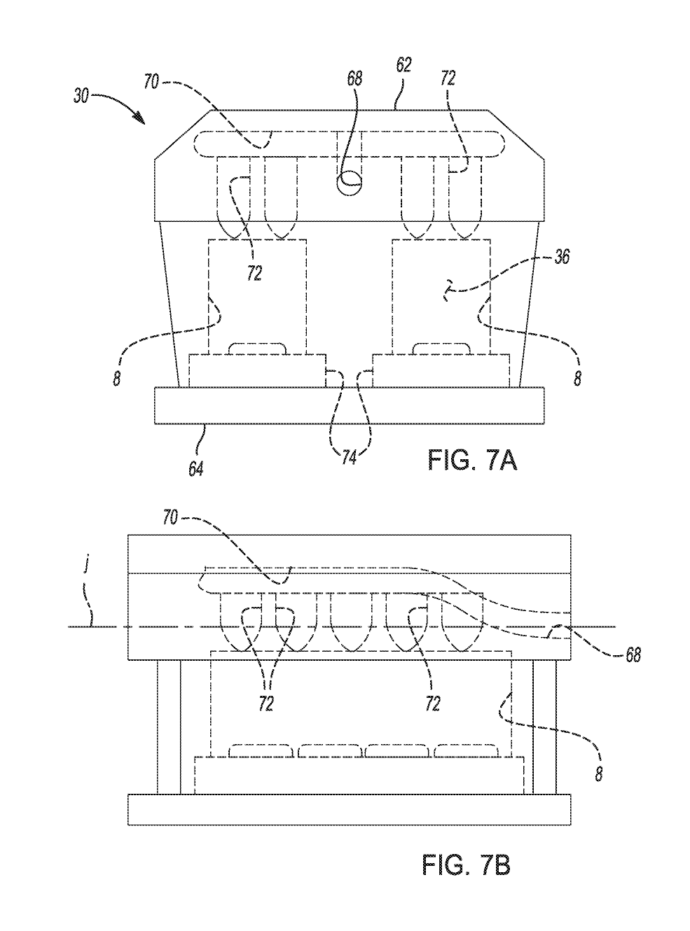

Of particular interest are the included features of the cope mold 62 and the drag mold 64. The cope mold 62, along with receiving the upper portion of the sand cores 32, includes a gating system 66 for receiving and feeding the mold assembly 30 with liquid metal. While a portion of the gating system 66 is viewable in FIG. 3, the gating system 66 is more completely shown in FIGS. 4 and 7B. The gating system 66 of the cope mold 62 includes an inlet 68, a runner 70, and a plurality of risers 72. More specifically, the inlet 68 receives the liquid metal from a metal source; such as an electromagnetic pump, and transfers the liquid metal to the runner 70. The runner 70 controls the flow rate and turbulence of the liquid metal by the diameter and shape of the runner 70. The runner 70 is in communication with and feeds liquid metal to the plurality of risers 72 which in turn feed the mold cavity 8 of the mold assembly 30.

The drag mold 64 is a sand mold 34 and includes a pair of head deck molds 74 that form the head deck 12 and combustion chambers 14 of the cylinder head 10. Separately, the head deck molds 74 are shown in FIG. 5. The head deck molds 74 are preferably made from a tool steel and placed in the drag mold 64 before the sand cores 32 are assembled into the mold assembly 30. Since the head deck molds 74 are made from a different material than the sand cores 32 or sand molds 34, the head deck molds 74 act as a chill or heat sink during the solidification of cast metal and provide a higher rate of cooling than provided by the sand of the sand cores 32 and sand molds 34.

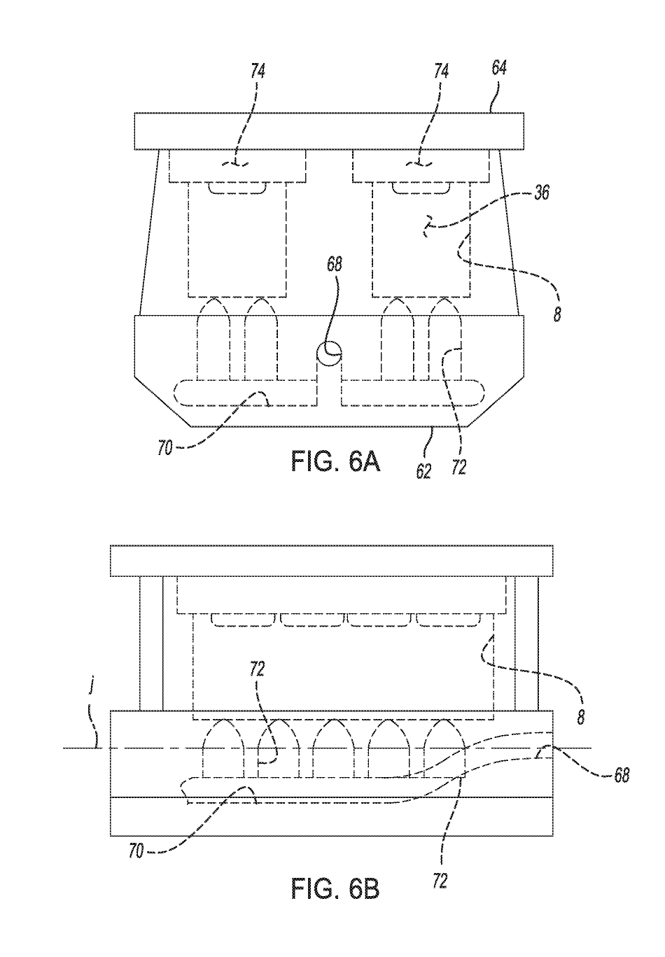

Turning now to FIGS. 6A and 6B to 9, steps for a method for manufacturing cast aluminum alloy cylinder heads 10 are illustrated and will now be described. After the mold assembly 30 is inspected and assembled, the mold assembly 30 is inserted into a machine, secured by hydraulic clamping mechanisms, and inverted such that the cope mold 62 of the mold assembly 30, and therefore the gating system 66, is upside down as shown in FIGS. 6A and 6B. A low pressure source of liquid aluminum is provided to the inlet 68 of the gating system 66. The liquid aluminum first fills the runner 70 and risers 72 before reaching the mold cavity 8, then filling the top portion of the cylinder head 10 first. As the liquid aluminum completely fills the mold cavity 8 the machine rotates the filled mold assembly 30 around an axis of rotation j so that the inlet 68 is still receiving low pressure liquid aluminum and mold assembly 30 is positioned such that the cope mold 62 is above the drag mold 64. At this point in the process, the low pressure source of liquid aluminum stops pumping. The mold assembly 30 is in the upright position as shown in FIGS. 7A and 7B with the last liquid aluminum, and therefore the hottest, to enter the mold assembly 30 is in the risers 72 of the gating system 66. The first liquid aluminum to solidify is located in the head deck 12 and combustion chambers 14.

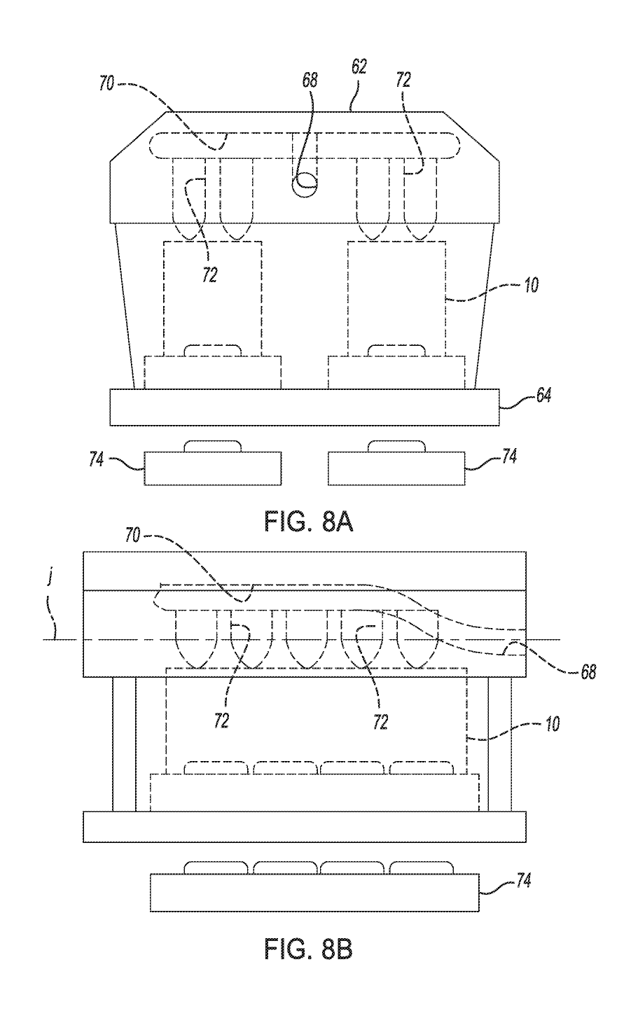

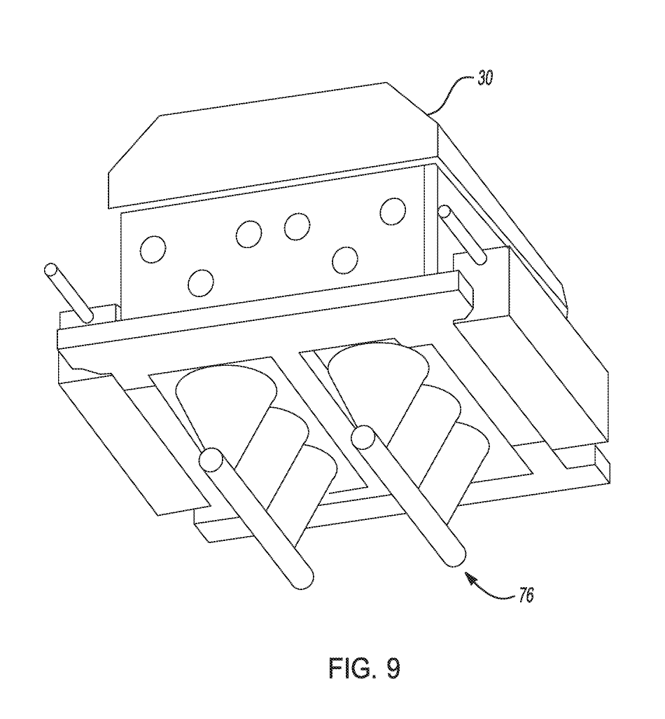

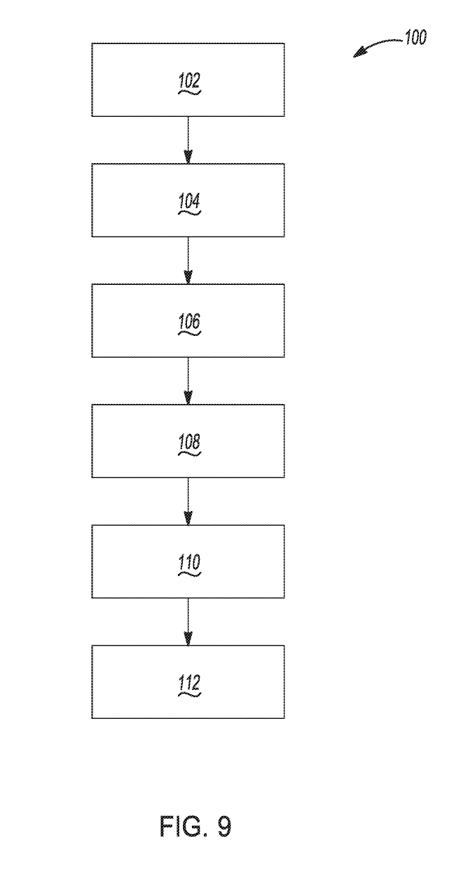

The next step of the method is illustrated in FIGS. 8A and 8B as the head deck molds 74 are removed from the drag mold 64 creating an access 76 to the solidified surface of the head deck 12 and combustion chambers 14. The head deck molds 74 are cooled, cleaned, and reinserted in a new mold assembly 30. The mold assembly 30 is positioned over quench system 78 as shown in FIG. 9. The quench system 78 introduces a pressurized water spray 80 through the access 76 of the drag mold 64 to further chill the head deck 12 and combustion chambers 14 at an even higher cooling rate than provided by the head deck molds 74. The pressurized water spray 80 continues for a prescribed time. The quench system 78 may also include a forced air or water mist cooling system without departing from the scope of the present invention. The mold assembly 30 is then loaded onto a pallet or rack and loaded into an oven for sand removal and a first heat treatment.

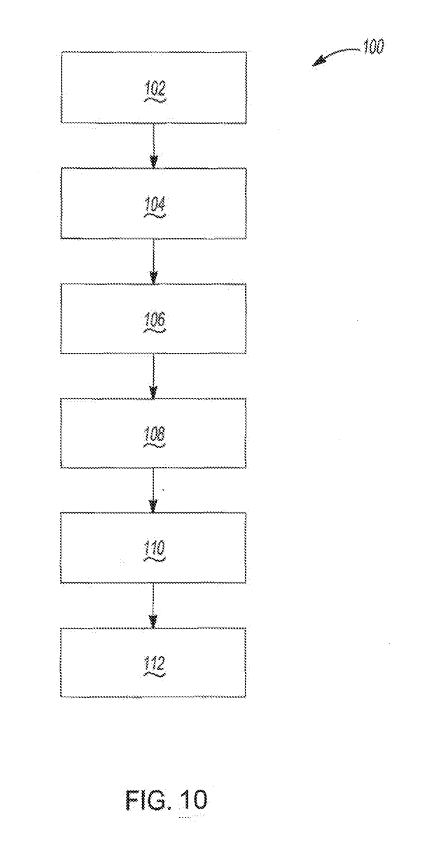

Referring now to FIG. 10, a flowchart depicting a method 100 for manufacturing an aluminum alloy cylinder head 10 will now be described. The method 100 begins with a first step 102 of providing a mold assembly 30 that is inverted. The mold assembly 30 includes a mold cavity 8, a cope mold 62 with a gating system 66 and a drag mold 64 with a pair of head deck molds 74. The mold assembly 30 is inverted such that the cope mold 62 is below the drag mold 64. A second step 104 fills the gating system 66 and mold cavity 8 using a low pressure liquid aluminum source. A third step 106 rotates or inverts the mold assembly 30 such that the cope mold 62 is above the drag mold 64. A fourth step 108 removes the head deck molds 74 from the drag mold 64. A fifth step 110 sprays chilled water on the head deck 12 and combustion chambers 14 of the cylinder head 10. A sixth step 112 places the mold assembly 30 in an oven for sand removal and heat treatment.

While the best modes for carrying out the invention have been described in detail, those familiar with the art to which this invention relates will recognize various alternative designs and examples for practicing the invention within the scope of the appended claims.

The following is claimed:

1. A method of manufacturing an aluminum alloy cylinder head, the method comprising;
providing a mold assembly including a gating system, a head deck mold, and a mold cavity;
pumping liquid aluminum alloy into the gating system of the mold assembly and filling the mold cavity;
removing the head deck mold from the mold assembly;
quenching a head deck and combustion chamber surface of the cylinder head formed by the head deck mold of the cylinder head.

2. The method of manufacturing an aluminum alloy cylinder head of claim 1, wherein providing a mold assembly including a gating system, a head deck mold, and a mold cavity further comprises providing a mold assembly including a cope mold, and a drag mold, and wherein the gating system is included in the cope mold, the head deck mold is included in the drag mold, and the mold assembly is inverted.

3. The method of manufacturing an aluminum alloy cylinder head of claim 1, wherein providing a mold assembly including a gating system, a head deck mold, and a mold cavity further comprises providing a mold assembly made of predominantly sand cores and including a head deck mold made of metal.

4. The method of manufacturing an aluminum alloy cylinder head of claim 2, wherein pumping liquid aluminum alloy into the gating system of the mold assembly and filling the mold cavity further comprises pumping liquid aluminum alloy into the gating system of the cope mold and completely filling the mold cavity.

5. The method of manufacturing an aluminum alloy cylinder head of claim 1, wherein removing the head deck mold from the mold assembly further comprises rotating the mold assembly and removing the head deck mold from the mold assembly.

6. The method of manufacturing an aluminum alloy cylinder head of claim 5, wherein quenching a head deck and combustion chamber surface of the cylinder head further comprises spraying the head deck and combustion chamber surface of the cylinder head with air, water, or a combination of air and water.

7. The method of manufacturing an aluminum alloy cylinder head of claim 1, further comprising transferring the filled mold assembly to an oven for sand removal and heat treatment.

8. The method of manufacturing an aluminum alloy cylinder head of claim 1, wherein pumping liquid aluminum alloy into the gating system of the mold assembly and filling the mold cavity further comprises pumping liquid aluminum into the gating system using an electromagnetic aluminum pump.

9. A method of manufacturing an aluminum alloy cylinder head, the method comprising:
providing a mold assembly including a cope mold, a drag mold, and a mold cavity, and wherein the cope mold includes a gating system, the drag mold includes a head deck mold, and the mold assembly is inverted;
pumping liquid aluminum alloy into the gating system of the mold assembly and completely filling the mold cavity;
removing the head deck mold from the drag mold, and
quenching a head deck and combustion chamber surface of the cylinder head formed by the head deck mold of the cylinder head.

10. The method of manufacturing an aluminum alloy cylinder head of claim 9, wherein providing a mold assembly including a gating system, a head deck mold, and a mold cavity further comprises providing a mold assembly made of predominantly sand cores and including a head deck mold made of metal.

11. The method of manufacturing an aluminum alloy cylinder head of claim 10, wherein removing the head deck mold from the mold assembly further comprises rotating the mold assembly and removing the head deck mold from the mold assembly.

12. The method of manufacturing an aluminum alloy cylinder head of claim 11, wherein quenching a head deck and combustion chamber surface of the cylinder head further comprises spraying the head deck and combustion chamber surface of the cylinder head with air, water, or a combination of air and water.

13. The method of manufacturing an aluminum alloy cylinder head of claim 12, further comprising transferring the filled mold assembly to an oven for cleaning and heat treatment.

14. A method of manufacturing an aluminum alloy cylinder head, the method comprising:
providing a mold assembly including a cope mold, a drag mold, and a mold cavity, and wherein the cope mold includes a gating system, and the drag mold includes a metal head deck mold for forming a head deck and combustion chamber of the cylinder head;
pumping liquid aluminum alloy into the gating system of the cope mold and completely filling the mold cavity;
rotating the mold assembly such that the cope mold is above the drag mold;
removing the head deck mold from the drag mold, and
quenching a head deck and combustion chamber surface of the cylinder head.

15. The method of manufacturing an aluminum alloy cylinder head of claim 14, wherein providing a mold assembly including a gating system, a head deck mold, and a mold cavity further comprises providing a mold assembly made of predominantly sand and resin and including a head deck mold made of metal.

16. The method of manufacturing an aluminum alloy cylinder head of claim 14, wherein providing a mold assembly including a gating system, a head deck mold, and a mold cavity further comprises providing an inverted mold assembly.

17. The method of manufacturing an aluminum alloy cylinder head of claim 16, wherein removing the head deck mold from the mold assembly further comprises rotating the mold assembly and removing the head deck mold from the mold assembly.

18. The method of manufacturing an aluminum alloy cylinder head of claim 14, wherein quenching a head deck and combustion chamber surface of the cylinder head further comprises spraying the head deck and combustion chamber surface of the cylinder head with air, water, or a combination of air and water.

19. The method of manufacturing an aluminum alloy cylinder head of claim 14, further comprising transferring the filled mold assembly to an oven for cleaning and heat treatment.

20. The method of manufacturing an aluminum alloy cylinder head of claim 14, wherein pumping liquid aluminum alloy into the gating system of the mold assembly and filling the mold cavity further comprises pumping liquid aluminum into the gating system using an electromagnetic aluminum pump.
